(19) United States
(12) Patent Application Publication
(10) Pub. No.: US 2026/0080555 A1
(43) Pub. Date: Mar. 19, 2026

(54) SHAPE RECOGNITION METHOD AND SHAPE RECOGNITION DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Toshiki SHIBANO, Toshima Tokyo (JP); Kozo Kinoshita, Fujisawa Kanagawa (JP); Takuya Matsumoto, Kawasaki Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/060,893

(22) Filed: Feb. 24, 2025

(30) Foreign Application Priority Data
Sep. 19, 2024 (JP) 2024-161623

(51) Int. Cl. G06T 7/60; G06T 7/00

(52) U.S. Cl. CPC G06T 7/60; G06T 7/0006; G06T 2207/30148

(57) ABSTRACT

According to one embodiment, a shape recognition method executed by a shape recognition device includes acquiring coordinate values in a first direction and a second direction in a captured image of an upper surface of a shape recognition target having an elliptical shape, calculating center coordinates of the elliptical shape based on distributions of the coordinate values, and calculating axial lengths of the elliptical shape based on the distributions of the coordinate values.

### CROSS-REFERENCE TO RELATED APPLICATIONS

This application is based upon and claims the benefit of priority from Japanese Patent Application No. 2024-161623, filed on Sep. 19, 2024; the entire contents of which are incorporated herein by reference.

### FIELD

Embodiments described herein relate generally to a shape recognition method and a shape recognition device.

### BACKGROUND

Conventionally, a shape recognition method in a device for determining a shape and a position of an ellipse of a semiconductor wafer employs a technique of extracting coordinate values of an edge of the semiconductor wafer.

However, in the related art, it might be difficult to recognize an accurate shape of the semiconductor wafer because noise is added to an edge to have a large effect.

An object of the present disclosure is to provide a shape recognition method and a shape recognition device, which can quickly and easily recognize the shape by having robustness that is less likely to be affected by the noise due to the edge.

### BRIEF DESCRIPTION OF THE DRAWINGS

FIG. 1 is a block diagram illustrating an example of a hardware configuration of a shape recognition device according to embodiments;

FIG. 2 is a block diagram illustrating an example of a configuration of a shape recognition device according to a first embodiment;

FIG. 3 is an example of an input image according to the first embodiment;

FIG. 4 is an example of raster-format coordinate information represented by each pixel from the input image in the first embodiment;

FIG. 5 is an example illustrating a distribution of the number of pixels in which a semiconductor wafer is present with respect to coordinates from the acquired coordinate information according to the first embodiment;

FIG. 6 is a flowchart of a procedure for deriving center coordinates and axial lengths of an ellipse in the first embodiment;

FIG. 7 is a block diagram illustrating an example of a configuration of a shape recognition device according to a second embodiment;

FIG. 8 is an example of an input image according to the second embodiment;

FIG. 9 illustrates an example in which an edge point group is extracted and an equation of an ellipse is calculated as an example of a method of deriving correction amounts in the second embodiment;

FIG. 10 is an example illustrating coordinate information of a semiconductor wafer in which an orientation flat is present as an example of the method of deriving the correction amount according to the second embodiment;

FIG. 11 is a flowchart illustrating an example of a procedure for deriving center coordinates and axial lengths of the ellipse in the second embodiment; and

FIG. 12 is an example of a flowchart of a procedure for deriving the correction amount in the second embodiment.

### DETAILED DESCRIPTION

In general, according to one embodiment, a shape recognition method executed by a shape recognition device includes: acquiring coordinate values in a first direction and a second direction in a captured image of an upper surface of a shape recognition target having an elliptical shape; calculating center coordinates of the elliptical shape based on distributions of the coordinate values; and calculating axial lengths of the elliptical shape based on the distributions of the coordinate values.

Exemplary embodiments of a shape recognition method and a shape recognition device of a semiconductor wafer will be explained below in detail with reference to the accompanying drawings. The present invention is not limited by the following embodiments.

### First Embodiment

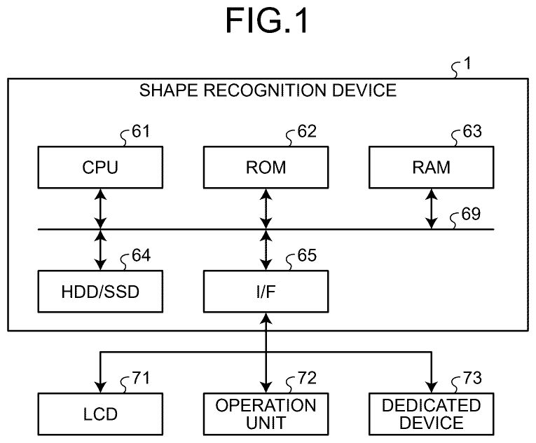

FIG. 1 is a block diagram illustrating an example of a hardware configuration of a shape recognition device according to embodiments. In the shape recognition device of the present embodiment, an image of a semiconductor wafer is transmitted to a shape recognition device 1 by a video source, a camera or the like. The shape recognition device 1 has a hardware configuration similar to that of an information processing device such as general PC or server. As an example, the shape recognition device includes a central processing unit (CPU) 61, a read only memory (ROM) 62, a random access memory (RAM) 63, a hard disk drive (HDD)/solid state drive (SSD) 64, and an I/F 65. The CPU 61, the ROM 62, the RAM 63, the HDD/SSD 64, and the I/F 65 are communicable via a bus 69 and the like.

The CPU 61 is an arithmetic means (processor). The CPU 61 controls an operation of an entire shape recognition device 1. The ROM 62 is a read-only non-volatile storage medium. The ROM 62 stores a program such as firmware. The RAM 63 is a volatile storage medium capable of reading and writing information at a high speed. The RAM 63 is used as a work area when the CPU 61 processes (performs an arithmetic operation of) information. The HDD/SSD 64 is a non-volatile storage medium capable of reading and writing information. The HDD/SSD 64 stores an operating system (OS), various control programs, application programs and the like.

Note that, not only the CPU 61 but also various arithmetic means (processors) such as a graphics processing unit (GPU), an application specific integrated circuit (ASIC), and a field-programmable gate array (FPGA) can be used as appropriate.

Note that, as the HDD/SSD 64, an HDD and an SSD may be used, or either one of the HDD and SSD may be used. The HDD/SSD 64 is not limited to the HDD or SSD, and a storage device such as a flash memory or a CD-ROM drive can be appropriately operated.

The I/F 65 is an interface circuit that connects the bus 69 to various types of hardware, networks and the like and controls this connection (communication). A liquid crystal display (LCD) 71, an operation unit 72, and a dedicated device 73 are connected to the I/F 65.

The LCD 71 is a visual user interface (display device) for a user to check a state of the shape recognition device 1. The operation unit 72 is a user interface (input device) for the user to input information to the shape recognition device 1, such as a keyboard and a mouse. Note that the LCD 71 and the operation unit 72 may be integrally configured as a touch panel display. Here, the LCD 71 is an example of a display unit.

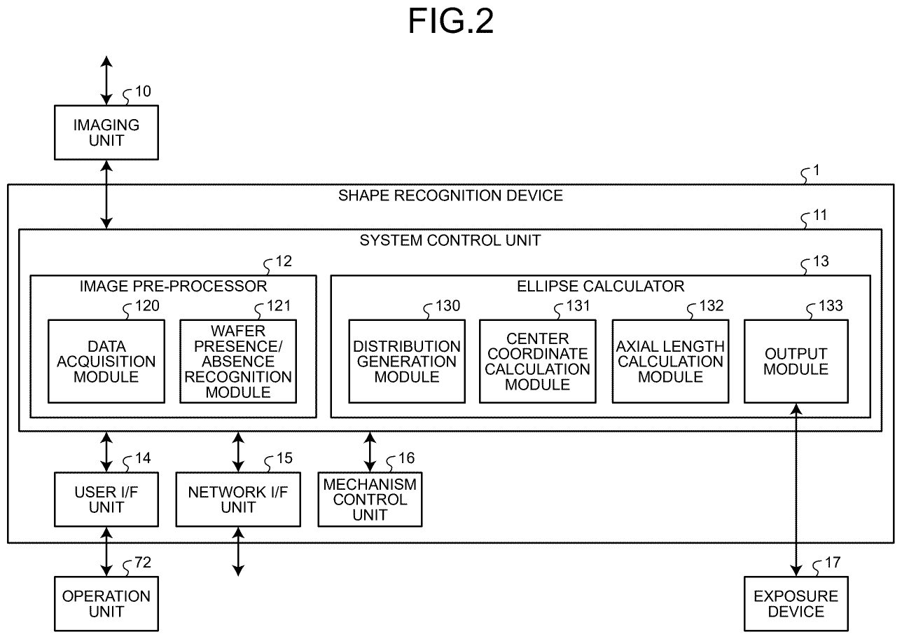

FIG. 2 is a block diagram illustrating an example of a functional configuration of the shape recognition device 1 according to a first embodiment. As illustrated in FIG. 2, the shape recognition device 1 includes an imaging unit 10, a system control unit 11, a user I/F unit 14, a network I/F unit 15, and a mechanism control unit 16.

The user I/F unit 14 is an I/F for connecting the system control unit 11 and the operation unit 72. The network I/F unit 15 is an I/F for connecting the system control unit 11 to a network such as a LAN. The mechanism control unit 16 is a control unit of an operation of the shape recognition device 1 such as a reading operation of the semiconductor wafer.

The imaging unit 10 provides an input image to the system control unit 11. The imaging unit 10 may be any unit such as the camera that can acquire image data. The system control unit 11 obtains a shape of the semiconductor wafer, that is, the center coordinates and axial lengths, as a shape recognition method, on the basis of the input image acquired by the imaging unit 10. The system control unit 11 includes an image pre-processor 12 and an ellipse calculator 13.

In order to obtain the center coordinates and the axial lengths from the input image acquired by the imaging unit 10, the image pre-processor 12 acquires data of coordinates with the semiconductor wafer and coordinates without the semiconductor wafer as illustrated in FIG. 4 to be described later. The image pre-processor 12 is integrated in its own field programmable gate array (FPGA) or application specific integrated circuit (ASIC), so that a processing time is short, and can be easily implemented in hardware.

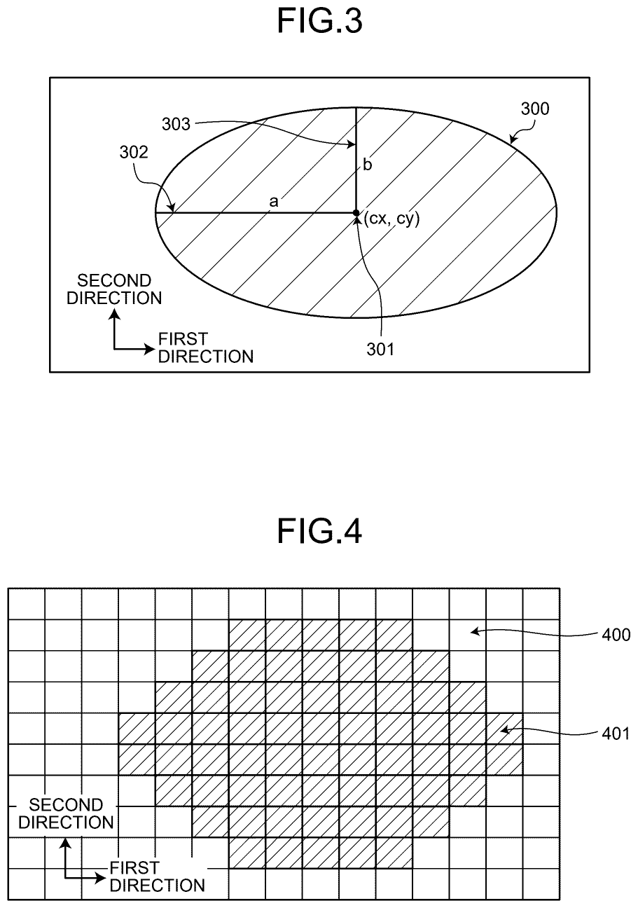

As illustrated in FIG. 2, the image pre-processor 12 includes a data acquisition module 120 and a wafer presence/absence recognition module 121. The data acquisition module 120 acquires the input image acquired by the imaging unit 10. FIG. 3 is an example of the input image according to the first embodiment. The imaging unit 10 such as the camera acquires an input image of the semiconductor wafer, and transmits the input image to the shape recognition device in association with each coordinate information in a first direction X and a second direction Y as illustrated in FIG. 4 to be described later. In the present embodiment, the shape of the semiconductor wafer is assumed to be an elliptical shape 300. Since an ellipse has higher expressive power than that of a circle, the shape of the semiconductor wafer can be obtained more accurately. From this input image, the shape recognition device 1 obtains center coordinates 301 (cx, cy), an axial length a in the first direction X a302, and an axial length b in the second direction Y b303. In addition to the input image as described above, wafer data acquired at a fixed feed pitch like a pixel may be used. For example, data such as a density and a film thickness, which are characteristics of the wafer, may be acquired at the fixed feed pitch.

The wafer presence/absence recognition module 121 determines presence or absence of the semiconductor wafer in the input image. Specifically, the wafer presence/absence recognition module 121 determines the presence or absence of the semiconductor wafer with respect to the input image, and converts the input image into data of a binary image in which a portion in which the wafer is present in each pixel forming the input image is “1” and the other portion is “0”. The data acquisition module 120 associates the data acquired as described above with each coordinate information to acquire the data as illustrated in FIG. 4 described later. FIG. 4 is an example of raster-format coordinate information represented by each pixel from the input image in the first embodiment. The input image transmitted from the imaging unit 10 is transmitted to the image pre-processor 12 in the shape recognition device 1. In the input image, a portion 401 in which the wafer is present is expressed as “1”, and the other portion 400 is expressed as “0” by each pixel. The data of the pixel corresponding to “1” is data associated with each coordinate information in the first direction X and the second direction Y as illustrated in FIG. 4.

The ellipse calculator 13 obtains the shape of the semiconductor wafer, that is, the center coordinates and the axial lengths on the basis of raster-format image data as illustrated in FIG. 4 obtained above. The ellipse calculator 13 includes a distribution generation module 130, a center coordinate calculation module 131, an axial length calculation module 132, and an output module 133.

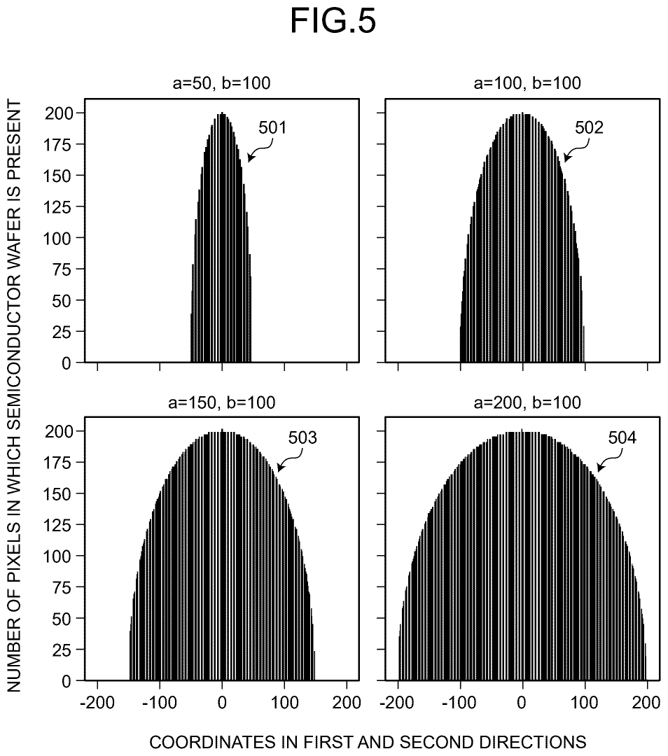

The distribution generation module 130 calculates a distribution of the number of pixels in which the semiconductor wafer is present from the raster-format image data illustrated in FIG. 4. FIG. 5 is an example illustrating the distribution of the number of pixels in which the semiconductor wafer is present with respect to the coordinates from the acquired coordinate information according to the first embodiment. Specifically, the distribution generation module 130 generates the distributions of the number of pixels in which the semiconductor wafer is present with respect to the coordinates in the first direction X and the second direction Y from data of raster-format coordinate information as illustrated in FIG. 4. FIG. 5 illustrates distributions (501 to 504) in the first direction X in a case where the axial length a in the first direction X and the axial length b in the second direction Y are a=50 and b=100, a=100 and b=100, a=150 and b=100, and a=200 and b=100, respectively. The center coordinate calculation module 131 and the axial length calculation module 132 calculate an average value and a standard deviation on the basis of these distributions, and calculate the shape of the semiconductor wafer (center coordinates (cx, cy), and axial lengths in first direction X and second direction Y (a, b)).

The center coordinate calculation module 131 calculates the center coordinates of the semiconductor wafer on the basis of the distributions as illustrated in FIG. 5. The center coordinate calculation module 131 acquires a coordinate distribution of the semiconductor wafer as illustrated in FIG. 5 in each of the first direction X and the second direction Y, and obtains average values MEAN(X) and MEAN(Y) for the respective coordinates on the basis of the distributions. Furthermore, the center coordinate calculation module 131 defines the average values of the coordinate distribution as the center coordinates (cx, cy) of the semiconductor wafer, using equation (1.1) as the center coordinates of the semiconductor wafer.

$$cx = MEAN ( X ) \qquad ( 1.1 )$$

$$cy = MEAN ( Y )$$

Here, MEAN represents a function for obtaining the average value. X and Y represent respectively a coordinate value of data in the first direction and a coordinate value of data in the second direction of each pixel.

The axial length calculation module 132 calculates the axial lengths of the semiconductor wafer on the basis of the distribution as illustrated in FIG. 5. The axial length calculation module 132 also acquires the coordinate distribution of the semiconductor wafer as illustrated in FIG. 5 in each of the first direction X and the second direction Y, and obtains standard deviations STD(X) and STD(Y) for the respective coordinates on the basis of the distributions. Furthermore, the axial length calculation module 132 defines twice the standard deviations of the coordinate distributions as the axial lengths a and b in the first direction X and the second direction Y of the semiconductor wafer by using equation (1.2) as the axial lengths of the semiconductor wafer.

$$a = 2 \times STD ( X ) \qquad ( 1.2 )$$

$$b = 2 \times STD ( Y )$$

Here, STD represents a function for obtaining the standard deviation. X and Y represent respectively a coordinate value of data in the first direction and a coordinate value of data in the second direction of each pixel.

The output module 133 transmits information such as the center coordinates (cx, cy) and the axial lengths a and b of the semiconductor wafer obtained in this manner to an exposure device 17.

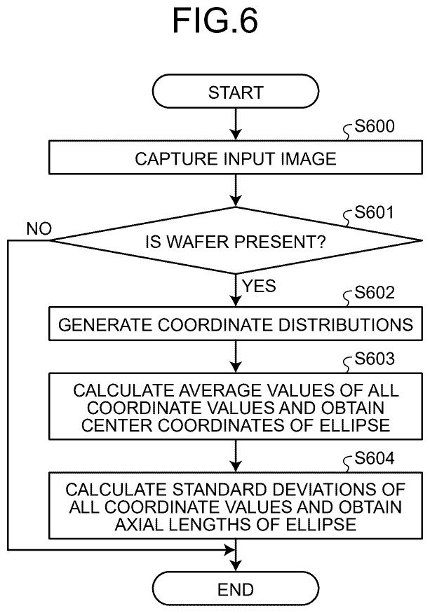

Next, a shape recognition procedure in the shape recognition device 1 according to the first embodiment will be described. FIG. 6 is a flowchart of a procedure for deriving the center coordinates and the axial lengths of the ellipse in the first embodiment. First, the imaging unit 10 acquires the input image of the semiconductor wafer as a shape recognition target (S600).

Subsequently, the wafer presence/absence recognition module 121 checks the presence or absence of the wafer from the acquired input image, and finishes processing as it is in a case where there is no wafer (S601: No). In contrast, when the wafer is present (S601: Yes), the processing is continued as it is. Subsequently, the distribution generation module 130 acquires coordinate distributions of the semiconductor wafer in the first direction X and the second direction Y from the acquired input image (S602). On the basis of the acquired coordinate distributions, the center coordinate calculation module 131 obtains the average values MEAN(X) and MEAN(Y) of the distributions. Then, the center coordinates (cx, cy) of the semiconductor wafer are obtained from the obtained average values by equation (1.1) (S603). This step corresponds to a “center coordinate calculation step”. Next, the axial length calculation module 132 obtains the standard deviations STD(X) and STD(Y) from the acquired coordinate distributions. The axial length calculation module 132 obtains the axial lengths a and b in the first direction X and the second direction Y of the semiconductor wafer from obtained values of the standard deviations by equation (1.2) (S604). This step corresponds to the “axial length calculation step”.

In this manner, in the present embodiment, since the shape recognition of the semiconductor wafer is performed only by the calculation of the average and the standard deviation, a calculation cost is small, and the processing can be performed quickly. For example, in a case where an edge is determined from the input image as in a comparative example, since a size and brightness of the pixel affect, noise is added to the edge, and there is a concern that the edge cannot be correctly determined. In the semiconductor wafer, since a sawtooth is further added to the edge by manufacturing, an influence is further increased. The present embodiment uses not only a specific edge but also a coordinate value including the inside of the wafer, and thus has robustness against edge noise.

A shape recognition method according to the present embodiment is a shape recognition method including an acquisition step of acquiring the coordinate values in the first direction X and the second direction Y in the captured image of the upper surface of the shape recognition target having the elliptical shape, a center coordinate calculation step of calculating the center coordinates of the elliptical shape on the basis of the distribution of the coordinate values, and an axial length calculation step of calculating the axial length of the elliptical shape on the basis of the distribution of the coordinate values.

Specifically, the shape recognition device 1 according to the present embodiment acquires the input image of the semiconductor wafer acquired by the imaging unit 10, generates distribution coordinates of the semiconductor wafer in the first direction and the second direction perpendicular to each other on the basis of the acquired input image, and calculates the average and the standard deviation from the acquired coordinate distribution. On the basis of these acquired values, the center coordinates and the axial lengths in the two directions of the semiconductor wafer are obtained, and the shape is recognized. As a result, the shape of the semiconductor wafer can be recognized without being affected by noise at the edge of the semiconductor wafer.

In the shape recognition method according to the present embodiment, at the center coordinate calculation step, the average value is calculated from the distribution of the coordinate values in the first direction and the second direction, and the calculated average value is set as the center coordinates, and at the axial length calculation step, the standard deviation is calculated from the distribution of the coordinate values in the first direction and the second direction, and the value obtained by multiplying the calculated standard deviation by two is calculated as the axial length. This makes it possible to quickly process inspection and analysis of the shape recognition with limited time and calculation resources.

### Second Embodiment

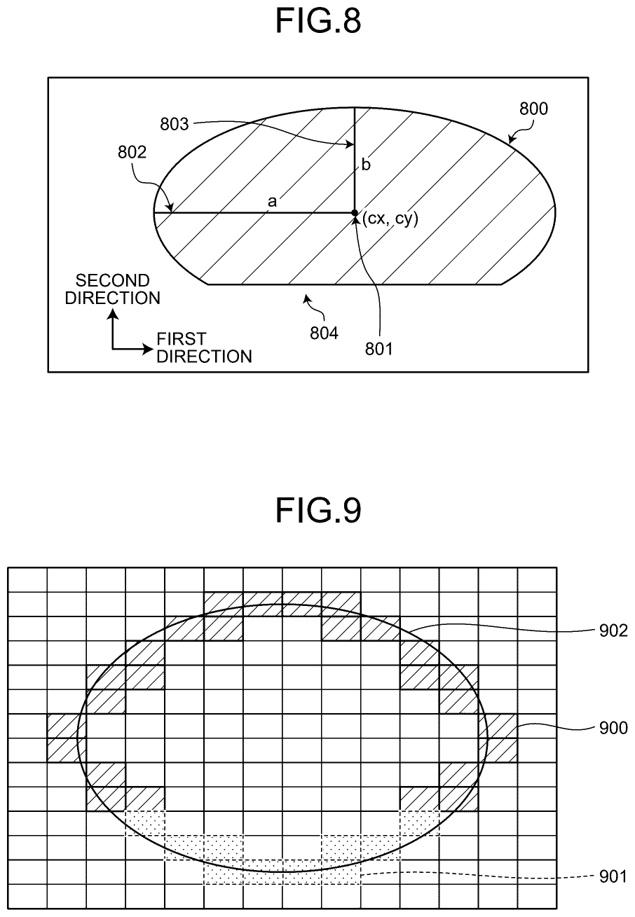

In the first embodiment, the center coordinates and the axial lengths are obtained on the assumption that the semiconductor wafer has the elliptical shape, but this second embodiment describes a shape recognition method of a semiconductor wafer in which an orientation flat and the like is present. The orientation flat refers to a flat portion formed in a lower portion of an elliptical shape as illustrated in FIG. 8 in order to indicate crystal orientation of the semiconductor wafer. In addition to the orientation flat, a shape the same every time such as a notch can be calculated in a manner similar to the present embodiment.

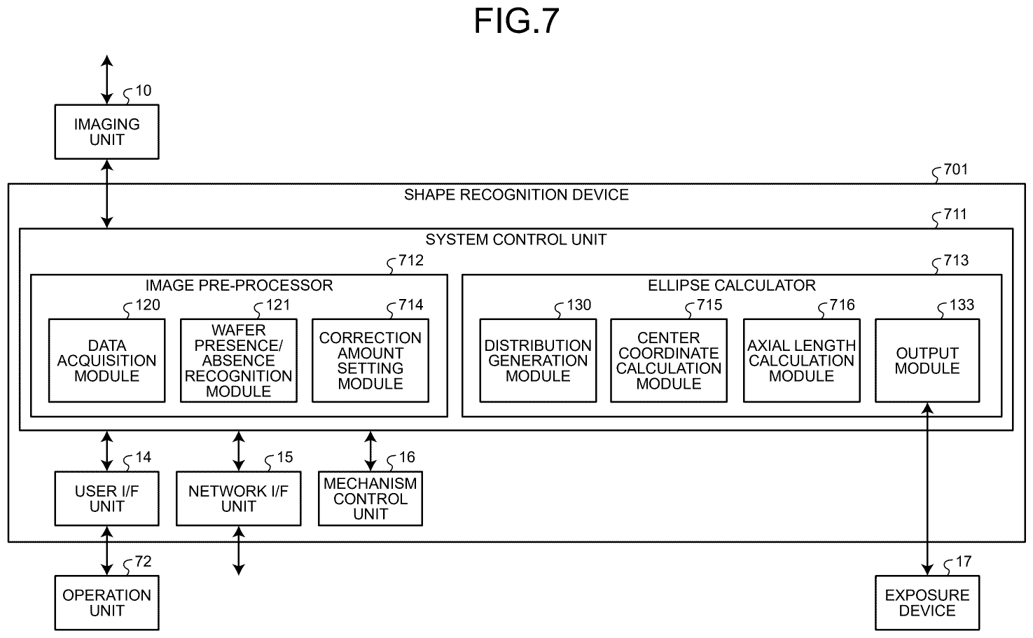

FIG. 7 is a block diagram illustrating an example of a configuration of a shape recognition device 701 according to the second embodiment. As illustrated in FIG. 7, the shape recognition device 701 according to the second embodiment includes a system control unit 711, an image pre-processor 712, and an ellipse calculator 713. The image pre-processor 712 includes a correction amount setting module 714, and the ellipse calculator 713 includes a center coordinate calculation module 715 and an axial length calculation module 716. In FIG. 2 described above, the same components as those of the first embodiment are denoted by the same reference numerals, and description thereof will be omitted.

Similarly to the first embodiment, an input image as illustrated in FIG. 8 is acquired from an imaging unit 10. FIG. 8 is an example of the input image according to the embodiment in the second embodiment. A shape of a semiconductor wafer assumed in the present embodiment is a shape 800 in which an orientation flat portion 804 having a flat portion under an ellipse is present. The shape of the semiconductor wafer is recognized by obtaining center coordinates 801, an axial length a in a first direction X a802, and an axial length b in a second direction Y b803 of the shape 800.

### Example of Method of Calculating Correction Amount

The correction amount setting module 714 derives a correction amount when obtaining the center coordinates and the axial lengths in a case where the orientation flat or the like is present. An example of a method of calculating the correction amount will be described below. First, in order to obtain the correction amount, the imaging unit 10 acquires the input image of a sample of the semiconductor wafer having the orientation flat as illustrated in FIG. 8. Next, a wafer presence/absence recognition module 121 extracts data of an edge point group of the sample of the semiconductor wafer on the basis of the acquired input image, and a data acquisition module 120 acquires the data.

FIG. 9 illustrates an example in which an edge point group is extracted and an equation of an ellipse is calculated as an example of a method of deriving correction amounts in the second embodiment. The data acquisition module 120 extracts an edge point group 900 in which an orientation flat portion 901 is present as illustrated in FIG. 9 from the acquired input image. The correction amount setting module 714 derives an equation 902 of an ellipse such as equation (2.1) using a least squares method on the basis of coordinate data of the edge point group excluding the orientation flat portion.

$${( \frac{X - {cx}^{′}}{{a}^{′}} )}^{2} + {( \frac{Y - {cy}^{′}}{{b}^{′}} )}^{2} = 1 \qquad ( 2.1 )$$

Here, cx′ and cy′ represent center coordinates of the equation of the ellipse, and a′ and b′ represent axial lengths in a first direction X and a second direction Y of the equation of the ellipse.

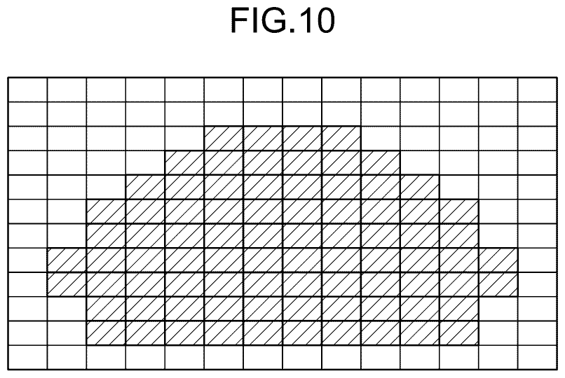

When the equation of the ellipse is obtained, the wafer presence/absence recognition module 121 recognizes a portion in which the semiconductor wafer is present and a portion in which the semiconductor wafer is not present from the input image from the input image of the sample of the semiconductor wafer, and associates the portions with each coordinate information in the first direction X and the second direction Y, thereby acquiring image data as illustrated in FIG. 10. FIG. 10 is an example illustrating the coordinate information of the semiconductor wafer in which the orientation flat is present as an example of the method of deriving the correction amount according to the second embodiment.

When acquiring the image data as illustrated in FIG. 10, a distribution generation module 130 acquires coordinate distributions of the semiconductor wafer in the first direction X and the second direction Y. The center coordinate calculation module 715 and the axial length calculation module 716 derive average values MEAN(X) and MEAN(Y) and standard deviations STD(X) and STD(Y) from the acquired coordinate distributions. Next, the correction amount setting module 714 obtains correction amounts kx, ky, ka, and kb from the center coordinates (cx′, cy′) and the axial lengths a′ and b′ of the above-described equation 902 of the ellipse by using equations (2.2) and (2.3).

$$kx = {cx}^{′} - MEAN ( X ) \qquad ( 2.2 )$$

$$ky = {cy}^{′} - MEAN ( Y )$$

$$ka = \frac{{a}^{′}}{STD ( X )} - 2 \qquad ( 2.3 )$$

$$kb = \frac{{b}^{′}}{STD ( Y )} - 2$$

In this manner, in a case where the shape of the semiconductor wafer having the orientation flat that is not an elliptical shape is recognized, it is necessary to calculate the correction amount in advance.

Returning to the description of FIG. 7, the center coordinate calculation module 715 calculates the center coordinates of the semiconductor wafer in which the orientation flat is present. Similarly to the first embodiment, the distribution generation module 130 calculates distributions of the number of pixels in which the semiconductor wafer is present with respect to the coordinates in the first and second directions. Then, the center coordinate calculation module 715 obtains the average values MEAN(X) and MEAN(Y) in the first (X) direction and the second (Y) direction on the basis of the generated coordinate distributions. The center coordinate calculation module 715 obtains the center coordinates (cx, cy) of the semiconductor wafer by using equation (2.4) from the above-described correction amounts and the average values of the coordinate distributions generated by the distribution generation module 130.

$$cx = MEAN ( X ) + kx \qquad ( 2.4 )$$

$$cy = MEAN ( Y ) + ky$$

Here, MEAN represents a function for obtaining the average value. X and Y represent respectively a coordinate value of data in the first direction and a coordinate value of data in the second direction of each pixel. Here, kx and ky are correction amounts in consideration of an influence of the orientation flat.

The axial length calculation module 716 obtains the standard deviations STD(X) and STD(Y) of the coordinate distributions for the respective coordinates on the basis of the distributions of the number of pixels in which the semiconductor wafer is present with respect to the coordinates in the first and second directions generated by the distribution generation module 130. The axial length calculation module 716 obtains the axial lengths a and b in the first direction X and the second direction Y of the semiconductor wafer by using equation (2.5) from the correction amounts described above and the standard deviation of the coordinate distributions generated by the distribution generation module 130.

$$a = ( 2 + ka ) \times STD ( X ) \qquad ( 2.5 )$$

$$b = ( 2 + kb ) \times STD ( Y )$$

Here, STD represents a function for obtaining the standard deviation. X and Y represent respectively a coordinate value of data in the first direction and a coordinate value of data in the second direction of each pixel. Here, ka and kb are correction amounts in consideration of the influence of the orientation flat.

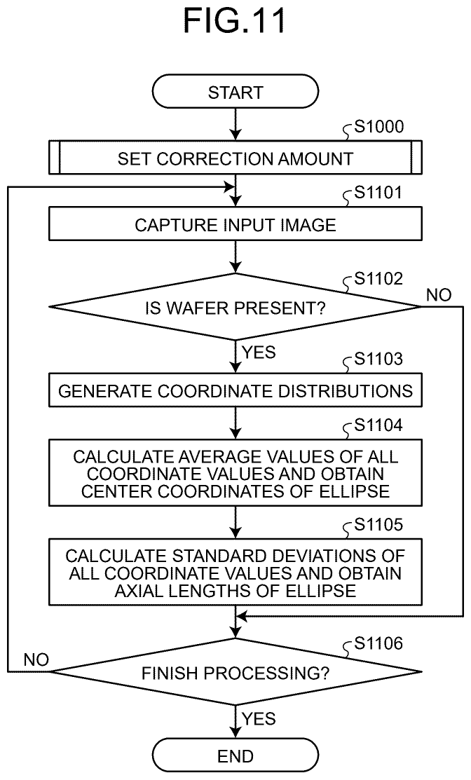

In the present embodiment, the shape recognition method of the semiconductor wafer including the orientation flat will be described with reference to FIG. 11. FIG. 11 is a flowchart illustrating an example of a procedure for deriving the center coordinates and the axial lengths of the ellipse in the second embodiment. First, the correction amount setting module 714 sets the correction amount corresponding to the shape of the semiconductor wafer such as the orientation flat in the shape recognition device 1 by the above-described method (S1100). This step corresponds to a “correction amount calculation step”.

When the derived correction amount is stored in the correction amount setting module 714, the imaging unit 10 captures the input image of the semiconductor wafer (S1101). Next, after capturing the input image, the wafer presence/absence recognition module 121 recognizes a portion in which the semiconductor wafer is present and a portion in which the semiconductor wafer is not present from the input image, and a mechanism control unit 16 causes a user to check whether to finish processing when the semiconductor wafer is not present (S1102: No), and continues the processing when the semiconductor wafer is present (S1102: Yes).

The distribution generation module 130 generates the coordinate distributions on the basis of binary data of the portion in which the semiconductor wafer is present and the portion in which the semiconductor wafer is not present acquired as described above and data associated with each coordinate in the first direction X and the second direction Y illustrated in FIG. 8 (S1103).

The center coordinate calculation module 715 obtains the average values MEAN(X) and MEAN(Y) for the respective coordinates on the basis of the generated coordinate distributions. Then, the center coordinate calculation module 715 obtains the center coordinates (cx, cy) of the semiconductor wafer from the average values of the coordinate distributions and the correction amounts kx and ky set by the correction amount setting module 714 by using equation (2.4) (S1104).

The axial length calculation module 716 obtains the standard deviations STD(X) and STD(Y) for the respective coordinates on the basis of the generated coordinate distributions. The axial length calculation module 716 obtains the axial lengths a and b in the first direction X and the second direction Y of the semiconductor wafer from the standard deviations of the coordinate distributions and ka and kb set by the correction amount setting module 714 using equation (2.5) (S1105).

When obtaining the center coordinates and the axial lengths of the ellipse, the user checks the calculated values with an LCD 71. In a case where the calculated value is not satisfactory, the mechanism control unit 16 captures the input image again, and acquires the input image again in order to obtain the center coordinates and the axial lengths again (S1106: No). If there is no problem in the value, the mechanism control unit 16 finishes the processing as job completion (S1106: Yes).

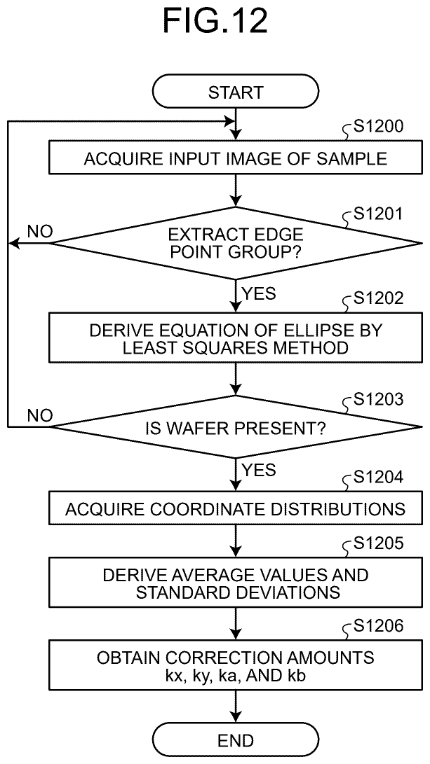

FIG. 12 is an example of a flowchart of a procedure for deriving the correction amount in the second embodiment. First, in order to obtain the correction amount, the imaging unit 10 acquires the input image of the sample of the semiconductor wafer having the orientation flat (S1200).

Next, the wafer presence/absence recognition module 121 extracts the data of the edge point group of the sample of the semiconductor wafer on the basis of the acquired input image, and in a case where the data cannot be extracted, this acquires the input image again (S1201: No), and continues the processing when the data can be acquired (S1201: Yes). The data acquisition module 120 extracts an edge point group 900 in which an orientation flat portion 901 is present as illustrated in FIG. 9 from the acquired input image. The correction amount setting module 714 derives the equation 902 of the ellipse such as equation (2.1) using a least squares method on the basis of coordinate data of the edge point group excluding the orientation flat portion (S1202). The mechanism control unit 16 acquires the input image again when it is recognized that the semiconductor wafer is not present from the acquired input image (S1203: No), and continues the processing when it is recognized that the semiconductor wafer is present (S1203: Yes).

When acquiring the image data as illustrated in FIG. 10, the distribution generation module 130 acquires the coordinate distributions of the semiconductor wafer in the first direction X and the second direction Y (S1204). The center coordinate calculation module 715 and the axial length calculation module 716 derive the average values MEAN(X) and MEAN(Y) and the standard deviations STD(X) and STD(Y) from the acquired coordinate distributions (S1205). Next, the correction amount setting module 714 obtains the correction amounts kx, ky, ka, and kb from the center coordinates (cx′, cy′) and the axial lengths a′ and b′ of the above-described equation 902 of the ellipse by using equations (2.2) and (2.3) (S1206).

Note that it is not required to derive the correction amount as illustrated in FIG. 12 for each wafer, and for example, in a case of a collection of wafers produced under equal conditions like a lot, the correction amount may be calculated by performing FIG. 12 on several wafers in the lot, and the remaining wafers of the same lot may follow the correction amount.

In the shape recognition method according to the present embodiment, at the center coordinate calculation step, the center coordinates are calculated by correcting the average values calculated from the distributions of the coordinate values in the first direction X and the second direction Y by the correction amounts, and at the axial length calculation step, the axial lengths are calculated by correcting the standard deviations calculated from the distributions of the coordinate values in the first direction X and the second direction Y by the correction amounts. As a result, even in a case of the semiconductor wafer in which the orientation flat and the notch are formed, the center coordinates and the axial lengths can be obtained from the average values and the standard deviations of the coordinate distributions calculated on the basis of the input image.

The shape recognition method according to the present embodiment further includes the correction amount calculation step of extracting the data of the edge point group from the shape recognition target and calculating the average values and the standard deviations acquired from equation (2.1) derived by the least squares method and the distributions of the coordinate values in the first direction X and the second direction Y and the correction amounts of the center coordinates and the axial lengths of the shape recognition target calculated from equations (2.2) to (2.3), in which the center coordinate calculation step calculates the center coordinates of the shape recognition target by correcting the average values calculated from the distributions of the coordinate values by the correction amounts of the center coordinates calculated at the correction value calculation step, and the axial length calculation step calculates the axial lengths of the shape recognition target by correcting the standard deviations calculated from the distributions of the coordinate values by the correction amounts of the axial lengths calculated at the correction amount calculation step. As a result, according to the present embodiment, even in a case where the shape of the semiconductor wafer in which the orientation flat and the notch are formed is recognized, the correction amount can be determined without determining the correction amount by comparing with the input image of the elliptical semiconductor wafer before the orientation flat and the notch are formed.

The shape recognition device 1, 701 using the shape recognition method according to the present embodiment is the shape recognition device including an acquisition module of acquiring the coordinate values in the first direction X and the second direction Y in the captured image of the upper surface of the shape recognition target having the elliptical shape, a center coordinate calculation module of calculating the center coordinates of the elliptical shape on the basis of the distribution of the coordinate values, and an axial length calculation module of calculating the axial lengths of the elliptical shape on the basis of the distributions of the coordinate values. As a result, according to the present embodiment, there is robustness against edge noise of the semiconductor wafer, and processing can be performed quickly with limited time and calculation resources.

In the above-described embodiment, the semiconductor wafer has been described as an example of the shape recognition target, but the shape recognition target is not limited to the semiconductor wafer as long as the shape recognition target has an elliptical shape.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shape recognition method executed by a shape recognition device, the method comprising:
acquiring coordinate values in a first direction and a second direction in a captured image of an upper surface of a shape recognition target having an elliptical shape;
calculating center coordinates of the elliptical shape based on distributions of the coordinate values; and
calculating axial lengths of the elliptical shape based on the distributions of the coordinate values.

2. The shape recognition method according to claim 1, wherein
the calculating the center coordinates includes calculating average values from the distributions of the coordinate values in the first direction and the second direction, and setting the calculated average values as the center coordinates, and
the calculating the axial lengths includes calculating standard deviations from the distributions of the coordinate values in the first direction and the second direction, and calculating values obtained by multiplying the calculated standard deviations by two as the axial lengths.

3. The shape recognition method according to claim 1, wherein
the calculating the center coordinates includes calculating the center coordinates by correcting average values calculated from the distributions of the coordinate values in the first direction and the second direction with correction amounts, and
the calculating the axial lengths includes calculating the axial lengths by correcting standard deviations calculated from the distributions of the coordinate values in the first direction and the second direction with correction amounts.

4. The shape recognition method according to claim 3, further comprising:
extracting data of an edge point group from the shape recognition target, and calculating average values and standard deviations acquired from equation (1) derived by a least squares method and distributions X and Y of the coordinate values in the first direction and the second direction, and correction values of the center coordinates and the axial lengths of the shape recognition target calculated from equations (2) to (5),
$${( \frac{X - {cx}^{′}}{{a}^{′}} )}^{2} + {( \frac{Y - {cy}^{′}}{{b}^{′}} )}^{2} = 1 \qquad ( 1 )$$
$$kx = {cx}^{′} - ( average value of X ) \qquad ( 2 )$$
$$ky = {cy}^{′} - ( average value of Y ) \qquad ( 3 )$$
$$ka = \frac{{a}^{′}}{( standard deviation of X )} - 2 \qquad ( 4 )$$
$$kb = \frac{{b}^{′}}{( standard deviation of Y )} - 2 \qquad ( 5 )$$
where cx′ and cy′ represent center coordinates of an equation of an ellipse, a′ and b′ represent axial lengths of the equation of the ellipse, and kx, ky, ka, and kb represent correction amounts, wherein
the calculating the center coordinates includes calculating the center coordinates of the shape recognition target by correcting the average values calculated from the distributions of the coordinate values with the correction amounts of the center coordinates calculated by calculating the correction amounts, and
the calculating the axial lengths includes calculating the axial lengths of the shape recognition target by correcting the standard deviations calculated from the distributions of the coordinate values with the correction amounts of the axial lengths calculated by calculating the correction amounts.

5. The shape recognition method according to claim 1, wherein
the shape recognition target includes a semiconductor wafer.

6. A shape recognition device comprising:
a processor configured to perform:
acquiring coordinate values in a first direction and a second direction in a captured image of an upper surface of a shape recognition target having an elliptical shape;
calculating center coordinates of the elliptical shape based on distributions of the coordinate values; and
calculating axial lengths of the elliptical shape based on the distributions of the coordinate values.

7. The shape recognition device according to claim 6, wherein
in the processor,
the calculating the center coordinates includes calculating average values from the distributions of the coordinate values in the first direction and the second direction, and setting the calculated average values as the center coordinates, and
the calculating the axial lengths includes calculating standard deviations from the distributions of the coordinate values in the first direction and the second direction, and calculating values obtained by multiplying the calculated standard deviations by two as the axial lengths.

8. The shape recognition device according to claim 6, wherein
in the processor,
the calculating the center coordinates includes calculating the center coordinates by correcting average values calculated from the distributions of the coordinate values in the first direction and the second direction with correction amounts, and
the calculating the axial lengths includes calculating the axial lengths by correcting standard deviations calculated from the distributions of the coordinate values in the first direction and the second direction with correction amounts.

9. The shape recognition device according to claim 8, wherein
the processor is further configured to perform:
extracting data of an edge point group from the shape recognition target, and calculating average values and standard deviations acquired from equation (6) derived by a least squares method and distributions X and Y of the coordinate values in the first direction and the second direction, and correction amounts of the center coordinates and the axial lengths of the shape recognition target calculated from equations (7) to (10),
$${( \frac{X - {cx}^{′}}{{a}^{′}} )}^{2} + {( \frac{Y - {cy}^{′}}{{b}^{′}} )}^{2} = 1 \qquad ( 6 )$$
$$kx = {cx}^{′} - ( average value of X ) \qquad ( 7 )$$
$$ky = {cy}^{′} - ( average value of Y ) \qquad ( 8 )$$
$$ka = \frac{{a}^{′}}{( standard deviation of X )} - 2 \qquad ( 9 )$$
$$kb = \frac{{b}^{′}}{( standard deviation of Y )} - 2 \qquad ( 10 )$$
where cx′ and cy′ represent center coordinates of an equation of an ellipse, a′ and b′ represent axial lengths of the equation of the ellipse, and kx, ky, ka, and kb represent correction amounts, wherein
the calculating the center coordinates includes calculating the center coordinates of the shape recognition target by correcting the average values calculated from the distributions of the coordinate values with the correction amounts of the center coordinates calculated by calculating the correction amounts, and
the calculating the axial lengths includes calculating the axial lengths of the shape recognition target by correcting the standard deviations calculated from the distributions of the coordinate values with the correction amounts of the axial lengths calculated by calculating the correction amounts.

10. The shape recognition device according to claim 6, wherein
the shape recognition target includes a semiconductor wafer.
